(19) United States
(12) Patent Application Publication
(10) Pub. No.: US 2007/0144225 A1
(43) Pub. Date: Jun. 28, 2007

(54) Electronic device system and lock device

(76) Inventor: Satoshi Tamura, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/643,278

(22) Filed: Dec. 21, 2006

(30) Foreign Application Priority Data
Dec. 23, 2005 (JP) 2005-371129

(51) Int. Cl. E05B 73/00

(52) U.S. Cl. 70/58

(57) ABSTRACT

According to one embodiment, an electronic device system includes a lock device including a hook portion which is rotatable between a lock position and an unlock position, and a rotation permission unit which permits rotation of the hook portion in a case where a permission signal is received, and an electronic device including a casing with a wall, a connection port which opens at the wall of the casing and to which the hook portion of the lock device is insertable, a detection unit which detects whether the lock device is inserted in the connection port, and a supply unit which supplies the permission signal to the rotation permission unit of the lock device in a case where the lock device is inserted in the connection port.

### CROSS-REFERENCE TO RELATED APPLICATIONS

This application is based upon and claims the benefit of priority from Japanese Patent Application No. 2005-371129, filed Dec. 23, 2005, the entire contents of which are incorporated herein by reference.

### BACKGROUND

1. Field

One embodiment of the invention relates to a lock device for preventing a theft of an electronic device, an electronic device, and an electronic device system including the lock device for preventing a theft of the electronic device.

2. Description of the Related Art

Recently, portable information devices, which are represented by portable computers, have widely been used. In order to enhance the portability of this type of portable computer, the reduction in size, thickness and weight has steadily been promoted. The portable computer can be put in a bag, for instance, and can easily be carried.

In general, the portable computer is used not only in the outdoors, but also on the desk in offices, like desktop computers. In this case, since the portable computer can easily be carried, if it is left on the desk, the possibility of a theft cannot be eliminated. Under the circumstances, the conventional portable computer has a slot for preventing a theft. The slot is designed for detachable connection of an antitheft device, and the slot is formed at one location on the side surface or rear surface of the casing of the portable computer (Jpn. Pat. Appln. KOKAI Publication No. 2000-56857).

The antitheft device for the portable computer includes, for example, a strong security cable that is formed by bundling metal wires, and a lock cylinder that is fixed to one end of the security cable. The lock cylinder has a hook-shaped head portion that is detachably inserted in the slot of the casing of the computer. The head portion is rotated between a lock position and an unlock position by a lock key.

After the security cable is tied to an external fixed object such as a desk in an office, the head portion of the lock cylinder is inserted in the slot of the casing and is locked. Thereby, the portable computer can securely be tied to the fixed object via the security cable. Thus, the movement or take-out of the portable computer is restricted, and an undesired theft of the portable computer can be prevented.

In the meantime, if the lock key is duplicated, the portable computer could easily be stolen. Therefore, there is a demand for the advent of a mechanism which prevents unlocking even if a lock key is duplicated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an example of the structures of a notebook personal computer (electronic device), which is usable as an electronic device system according to a first embodiment of the invention, and a security wire and a remote control which function as a lock device;

FIG. 2 is an exemplary block diagram showing an example of the system configuration of the computer, security wire and remote control;

FIG. 3 is an exemplary flow chart illustrating the procedure of a process for connecting the computer 10 and security wire 200 in the state in which the computer 10 is active;

FIG. 4 is an exemplary flow chart illustrating a procedure for removing the security wire from the computer main body by rotating a hook of the security wire to an unlock position in the state in which the system is active; and

FIG. 5 is an exemplary flow chart illustrating a procedure for turning on power and booting up the system.

### DETAILED DESCRIPTION

Various embodiments according to the invention will be described hereinafter with reference to the accompanying drawings. In general, according to one embodiment of the invention, an electronic device system comprises a lock device including a hook portion which is rotatable between a lock position and an unlock position, and a rotation permission unit which permits rotation of the hook portion in a case where a permission signal is received, and an electronic device including a casing with a wall, a connection port which opens at the wall of the casing and to which the hook portion of the lock device is insertable, a detection unit which detects whether the lock device is inserted in the connection port, and a supply unit which supplies the permission signal to the rotation permission unit of the lock device in a case where the lock device is inserted in the connection port.

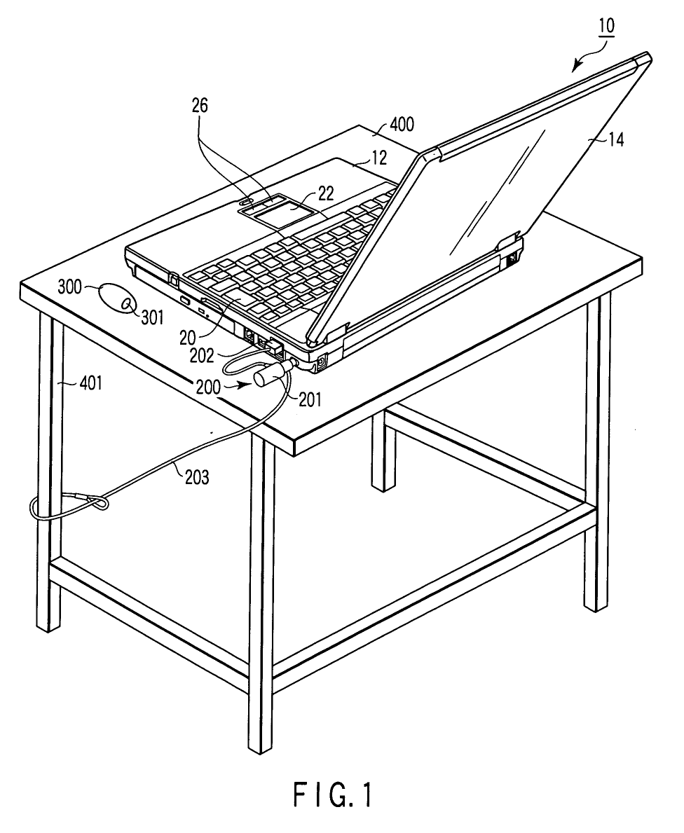

FIG. 1 shows an example of the structures of a notebook personal computer (electronic device), which is usable as an electronic device system according to a first embodiment of the invention, and a security wire and a remote control which function as a lock device.

A personal computer 10 comprises a computer main body 12 and a display unit 14.

The display unit 14, which is a display section, is attached to hinges which are provided at a rear end part of the computer main body 12 so that the display unit 14 is rotatable between an open position where the top surface of the computer main body 12 is exposed and a closed position where the top surface of the computer main body 12 is covered.

The computer main body 12 has a thin boxed-shaped casing, and a keyboard 20 is provided on a central part of the upper surface of the casing. A palm rest is formed on a front-side upper surface of the casing of the computer main body 12. A touch pad 22 and touch pad control buttons 26 are provided on a substantially central part of the palm rest. A power button for powering on/off the computer main body 12 is disposed on a rear-side upper surface of the casing of the computer main body 12.

A hook provided on a head portion 201 of a security wire 200 is inserted in a security slot (connection port) which is provided in a peripheral part of the casing of the computer main body 12. Thereby, the computer main body 12 and security wire 200 are connected. A USB connector 202 of the security wire 200 is inserted in a USB port which is provided on a peripheral part of the computer main body 12.

One end portion of a cable 203 of the security wire 200 is non-detachably connected to the head portion 201 of the security wire 200. The other end portion of the cable 203 is tied to a desk 401 which is an external fixed object that is hardly movable, thereby preventing a theft of the computer 10.

A remote control 300 is placed on the desk 401. By an operation of a button 301, the remote control 300 instructs the security wire 200 to execute connection/disconnection.

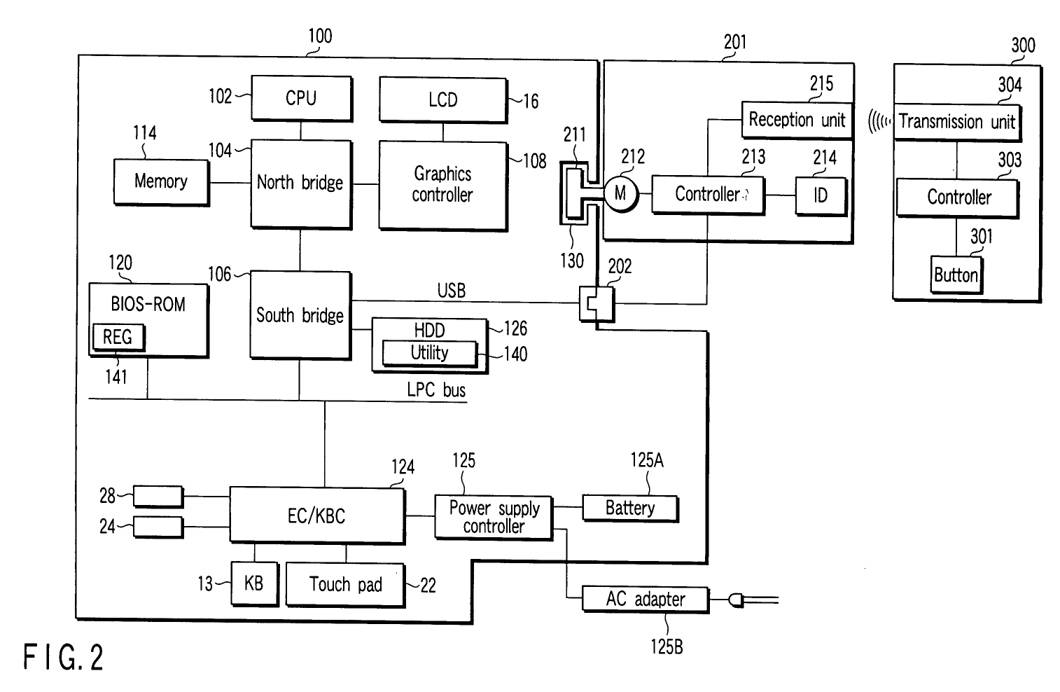

Next, referring to FIG. 2, an example of the system configuration of the computer, security wire and remote control is described.

As is shown in FIG. 2, the computer includes a CPU 102, a north bridge 104, a main memory 114, a graphics controller 108, a south bridge 106, a BIOS-ROM 120, a hard disk drive (HDD) 126, an embedded controller/keyboard controller IC (EC/KBC) 124, and a power supply controller 125.

The CPU 102 is a processor which is provided in order to control the operation of the computer. The CPU 102 executes an operating system (OS) and various application programs such as a utility 140, which are loaded in the main memory 114 from the hard disk drive (HDD) 126.

In addition, the CPU 102 loads a system BIOS (Basic Input/Output System), which is stored in the BIOS-ROM 120, into the main memory 114 and then executes the system BIOS. The system BIOS is a program for hardware control.

The north bridge 104 is a bridge device which connects a local bus of the CPU 102 and the south bridge 106. The north bridge 104 includes a memory controller which access-controls the main memory 114. The north bridge 104 also has a function of executing communication with the graphics controller 108 via, e.g. an AGP (Accelerated Graphics Port) bus.

The graphics controller 108 is a display controller which controls an LCD 16 that is used as a display monitor of the computer. The graphics controller 108 includes a video memory (VRAM) and generates a video signal, which forms a display image to be displayed on the LCD 16, on the basis of display data which is rendered in the video memory by the OS/application program. The video signal that is generated by the graphics controller 108 is output to a line.

The embedded controller/keyboard controller IC (filter control unit) 124 functions as a controller which controls the touch pad 22 and touch pad control buttons 26 that are input means. The embedded controller/keyboard controller IC 124 is a one-chip microcomputer which monitors and controls various devices (peripheral devices, a sensor, a power circuit, etc.) regardless of the system state of the computer 10.

The power supply controller 125 generates system power, which is to be supplied to the respective components of the computer 10, by using power from a battery 125A or external power that is supplied via an AC adapter 125B.

The security wire 200 has a hook 211 which is inserted in a security slot 130 that is provided in the computer main body 12. The hook 211 is rotated from an unlock position to a lock position by a motor 212. Thereby, the hook 211 is engaged with the edge part of the security slot 130 and connected to the security slot 130.

In accordance with an instruction from a controller 213, the motor 212 rotates the hook 211 from the unlock position to the lock position, or from the lock position to the unlock position.

The controller 213 drives the motor 212 when the button 301 of the remote control 300 is operated.

When a user operates the button 301 of the remote control 300, the controller 303 transmits a lock/unlock signal from a transmission unit 304 by using a wireless signal. A reception unit 215, which is provided at the head portion 201 of the security wire 200, receives the lock/unlock signal that is transmitted from the transmission unit 304 of the remote control 300, and sends the received lock/unlock signal to the controller 213. The lock/unlock signal may be transmitted/received by using an infrared signal instead of the wireless signal.

Power for driving the motor 212 and controller 213, which are provided in the head portion 201 of the security wire 200, is supplied from the USB port via the USB connector 202. The controller 213, which is a rotation permitting unit, includes a power supply control circuit, and supplies power to the reception unit 215 when a power supply permission signal is generated from the computer main body 12.

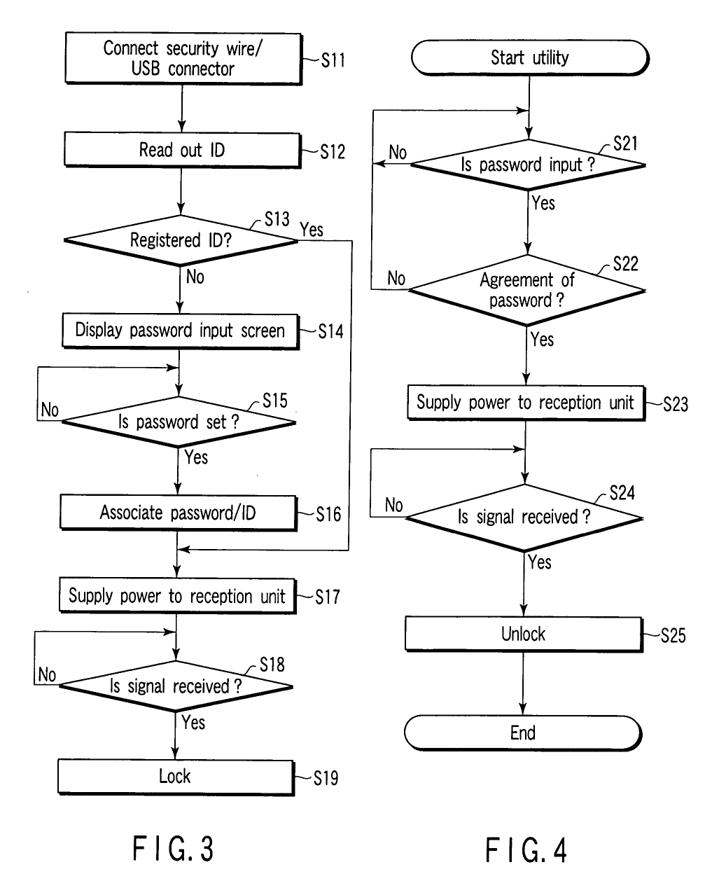

Next, referring to a flow chart of FIG. 3, a description is given of the procedure of a process for connecting the computer 10 and security wire 200 in the state in which the computer 10 is active.

In the state in which the computer is operating, the user inserts the hook 211 of the security wire 200 in the security slot provided in the computer main body 12, and inserts the USB connector in the USB port (step S11). A USB controller, which functions as a detection unit that is incorporated in the south bridge 106, detects the insertion of the USB connector 202. The USB controller informs a driver, which is a resident program on the system, of the insertion of the USB connector 202, and supplies power to the security wire 200 by making use of a USB power-supply function. The driver automatically starts the utility 140. In this embodiment, a mechanism for directly detecting the insertion of the hook 211 in the security slot 130 is not provided. Instead, the insertion of the hook 211 in the security slot 130 is detected by detecting the insertion/removal of the USB connector 202 in/from the USB port.

The utility 140 which functions as a read unit reads out ID information from an ID information storage unit 214 (step S12). The utility 140 determines whether the read-out ID information is already registered in a register 141 which is a registration unit (step S13). If the read-out ID information is not stored in the register 141 (No in step S13), the utility 140 displays a password input screen on the LCD 16 (step S14).

The utility 140 waits until a password is set (step S15). If the password is set (Yes in step S15), the utility 140 associates the set password with the ID information that is read out of the security wire 200, and registers the ID information in the register 141 (step S16).

If the ID information is registered in the register 141 (Yes in step S13), or after the registration in the register 141 by the process of step S14, the utility 140 sends a power supply permission signal to the controller 213 and instructs the controller 213 to supply power to the reception unit 215. In accordance with an instruction from the utility 140, the controller 213 supplies power to the reception unit 215 (step S17).

The controller 213 waits until a lock/unlock signal is received from the remote control 300 (step S18). If the lock/unlock signal is received (Yes in step S18), the controller 213 drives the motor 212 and rotates the hook 211 to the lock position (step S19). Then, the controller 213 stops supply of power to the reception unit 215.

By the above process, the computer main body 12 and security wire 200 can be connected by the computer 10 side control.

In the meantime, in the case where the ID information that is read out of the security wire 200 is registered in the register 141, the motor 212 may be driven to rotate the hook 211 to the lock position.

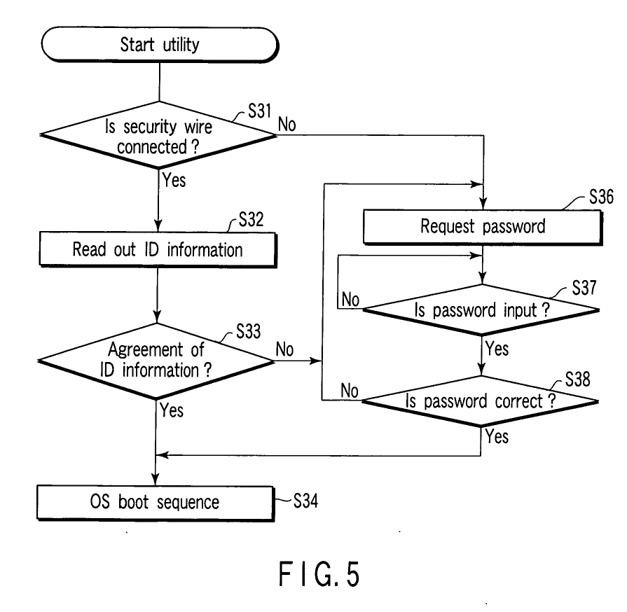

Next, referring to a flow chart of FIG. 4, a description is given of the procedure for removing the security wire 200 from the computer main body 12 by rotating the hook 211 of the security wire 200 to the unlock position in the state in which the system is active.

The user activates the utility 140 in order to remove the security wire 200 from the computer main body 12. The utility 140 waits until the user inputs the password (step S21). If the password is input (Yes in step S21), the input password is registered in the register and it is determined whether the input password agrees with the password associated with the ID information (step S22). If the password disagrees (No in step S22), the process procedure returns to step S21.

If the password agrees (Yes in step S22), the utility 140 sends a power supply permission signal to the controller 213 of the security wire 200 and instructs the controller 213 to supply power to the reception unit 215. The controller 213 supplies power to the reception unit 215 (step S23).

The controller 213 waits until the lock/unlock signal is received from the remote control 300 (step S24). If the lock/unlock signal is received (Yes in step S24), the controller 213 drives the motor 212, thereby rotating the hook 211 to the unlock position (step S25). Subsequently, the supply of power to the security wire 200 from the computer 10 is stopped, thus enabling the USB connector 202 to be removed from the USB port.

Thereafter, the user removes the hook 211 from the security slot 130 and disconnects the USB connector 202 from the USB port. Thus, the security wire 200 can be removed from the computer body 12.

By the above process, when the system is booted up, the hook 211 of the security wire 200 can be rotated only when the password input by the user agrees. Even if there is a remote control having the lock/unlock function, the lock cannot be released.

When the system is inactive, no power is supplied from the USB port, and the hook 211 cannot be driven. It is possible to provide the head portion 201 with a special line for constantly supplying power, without using the USB connector 202. In this case, in the state in which the system is not active, the hook 211 can be rotated only by the operation of the remote control 300.

Next, referring to a flow chart of FIG. 5, the procedure for turning on power and booting up the system is described.

The system BIOS determines whether the security wire 200 is connected to the computer main body 12 (step S31). The system BIOS determines whether the security wire 200 is connected to the computer main body 12 by detecting whether the USB connector is inserted in the USB port.

If the security wire is connected (Yes in step S31), the system BIOS sends a power supply permission signal to the controller 213 of the security wire 200 and instructs the controller 213 to supply power to the reception unit 215.

The ID information stored in the ID information storage unit 214 is read out (step S32). The system BIOS determines whether the read-out ID information agrees with the ID information that is registered in the register 141 (step S33). If the ID information agrees (Yes in step S33), the system BIOS skips an authentication process which is executed by using the user password, and starts a boot sequence for booting up the operating system (step S34).

If it is determined that the security wire is not connected (No in step S31) or if the ID information disagrees (No in step S33), the system BIOS displays on the LCD 16 an authentication screen for requesting input of the user password (step S36). The authentication screen displays a text message (PASSWORD=) for requesting input of the user password.

The system BIOS waits until the user inputs the user password (step S37). If the user password is input (Yes in step S37), the system BIOS determines whether the input user password is correct or not (step S38).

If the input user password is correct (Yes in step S38), the system BIOS starts the boot sequence for booting up the operating system (step S34).

By the above process, when the security wire 200 is connected to the computer main body 12, the input of the user password can be omitted and the boot-up of the system can be simplified.

In the above system, the connection of the security wire 200 is determined by the insertion of the USB connector 202. In this case, since it is determined whether the ID information stored in the security wire 200 agrees with the ID information registered in the register 141, the system cannot be booted up even if the USB connector 202 of the non-registered security wire 200 is inserted in the USB port.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device system comprising:
a lock device including a hook portion which is rotatable between a lock position and an unlock position, and a rotation permission unit which permits rotation of the hook portion in a case where a permission signal is received; and
an electronic device including a casing with a wall, a connection port which opens at the wall of the casing and to which the hook portion of the lock device is insertable, a detection unit which detects whether the lock device is inserted in the connection port, and a supply unit which supplies the permission signal to the rotation permission unit of the lock device in a case where the lock device is inserted in the connection port.

2. The electronic device system according to claim 1, wherein the lock device further includes a storage unit which stores identification information,
the electronic device further includes a read unit which reads out the identification information stored in the storage unit, and a registration unit in which the identification information read out by the read unit is registered, and
the rotation permission unit supplies the permission signal to the rotation permission unit in a case where the identification information, which is read out by the read unit from the lock device inserted in the connection port, is registered in the registration unit.

3. The electronic device system according to claim 2, wherein the electronic device further includes an input unit which enables a user to input information,
authentication information which is associated with the identification information is further registered in the registration unit, and
the rotation permission unit supplies the permission signal to the rotation permission unit in a case where the information input by the user agrees with the authentication information registered in the registration unit when the hook portion is in a lock position.

4. The electronic device system according to claim 2, wherein the electronic device includes a boot unit which executes a boot process of an operating system in a case where the identification information read out by the read unit agrees with the identification information registered in the registration unit at a time of powering on the electronic device and in a case where the identification information read out by the read unit is stored in the storage unit.

5. The electronic device system according to claim 2, further comprising a motor which rotates the hook portion.

6. The electronic device system according to claim 5, wherein the lock device includes a remote control device which transmits a rotation signal, a reception unit which receives the rotation signal that is transmitted from the remote control device, and a driving control unit which drives the motor in a case where the reception unit receives the rotation signal.

7. The electronic device system according to claim 5, wherein the rotation permission unit supplies power to the reception unit in a case where the permission signal is supplied.

8. The electronic device system according to claim 5, wherein the rotation permission unit drives the motor in a case where the permission signal is supplied to the rotation permission unit after the detection unit detects that the lock device, which is yet to be inserted in the connection port, is inserted in the connection port.

9. A lock device comprising:
a hook portion which is rotatable between a lock position and an unlock position; and
a rotation permission unit which permits rotation of the hook portion in a case where a permission signal is received.

10. The lock device according to claim 9, further comprising a motor which rotates the hook portion.

11. The lock device according to claim 10, further comprising:
a remote control device which transmits a rotation signal; and
a driving control unit which drives the motor in accordance with the rotation signal that is transmitted from the remote control device.
